(19) United States
(12) Patent Application Publication
(10) Pub. No.: US 2012/0229395 A1
(43) Pub. Date: Sep. 13, 2012

(54) Touch Screen Panel

(76) Inventor: Seob Shin, Yongin-city (KR)

(21) Appl. No.: 13/397,530

(22) Filed: Feb. 15, 2012

(30) Foreign Application Priority Data
Mar. 9, 2011 (KR) 10-2011-0020872

(51) Int. Cl. G06F 3/041

(52) U.S. Cl. 345/173

(57) ABSTRACT

A touch screen panel includes a plurality of first and second sensing electrodes crossing each other and a plurality of coupling pads. Each of the coupling pads is coupled to a respective end of a corresponding one of the first sensing electrodes or the second sensing electrodes. The touch screen panel further includes a repair wiring line and an insulating layer interposed between the coupling pads and the repair wiring line. A defect such as a short is repairable by the repair wiring line so that manufacturing cost may be reduced.

### CROSS-REFERENCE TO RELATED APPLICATION

This application claims priority to and the benefit of Korean Patent Application No. 10-2011-0020872, filed on Mar. 9, 2011, in the Korean Intellectual Property Office, the entire content of which is incorporated herein by reference.

### BACKGROUND

1. Field

An embodiment of the present invention relates to a touch screen panel, and more particularly, to a touch screen panel having repair wiring lines.

2. Description of the Related Art

A touch screen is an input device capable of selecting the indication (or instruction) content displayed on the screen of an image display device by a human hand or an object in order to input the command of a user.

Therefore, the touch screen is provided on the front face of the image display device to convert a contact position touched by the human hand or the object into an electrical signal. Therefore, the instruction content selected at the contact position is received as an input signal.

Since the touch screen may replace an input device coupled to the image display device such as a keyboard or a mouse, the applications of the touch screen are gradually increasing.

Methods of realizing a touch screen panel include a resistance layer method, a photo-sensing method, and an electrostatic capacity method.

According to the electrostatic capacity (or capacitive) method, a touch screen panel includes a plurality of sensing electrodes formed to be dispersed in a touch active region. The point or location where electrostatic capacity changes when a human hand or an object contacts the touch screen panel is detected by the plurality of sensing electrodes to determine a contact position.

However, the sensing electrodes are often broken or damaged by scratching, static electricity, or a short is often generated among the sensing electrodes. There is no known method of repairing such defect so that loss of material cost is severe. In addition, when the defect occurs in a module process, the entire module becomes defective.

### SUMMARY

Accordingly, embodiments of the present invention are directed toward a touch screen panel in which a defect such as a short can be repaired by repair wiring lines so that manufacturing cost is reduced.

According to an embodiment of the present invention, a touch screen panel includes a plurality of first and second sensing electrodes crossing each other, a plurality of coupling pads, each of the coupling pads being coupled to a respective end of a corresponding one of the first sensing electrodes or the second sensing electrodes, a repair wiring line, and an insulating layer interposed between the coupling pads and the repair wiring line.

The coupling pads may be positioned at a same layer as the first and second sensing electrodes.

The coupling pads may include a same material as the first and second sensing electrodes.

The touch screen panel may further include a plurality of driving wiring lines respectively coupled to the coupling pads.

Each of the driving wiring lines may be coupled to one of the two coupling pads coupled to both ends of a corresponding one of the first and second sensing electrodes.

The coupling pads may respectively couple the driving wiring lines and the first and second sensing electrodes to each other through contact holes in the insulating layer.

The repair wiring line may include a plurality of repair wiring lines.

The repair wiring lines may be positioned at a same layer as the driving wiring lines.

The repair wiring lines may include a same material as the driving wiring lines.

The first sensing electrodes may include a plurality of first sensing cells and a plurality of first coupling patterns for respectively coupling the plurality of first sensing cells to each other. The second sensing electrodes may include a plurality of second sensing cells and a plurality of second coupling patterns for respectively coupling the plurality of second sensing cells to each other.

The repair wiring line may include a plurality of coupling units to be respectively coupled to the coupling pads.

As described above, according to embodiments of the present invention, there may be provided the touch screen panel capable of repairing a defect such as a short by the repair wiring lines so that manufacturing cost is reduced.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a plan view illustrating a touch screen panel according to a first embodiment of the present invention;

FIG. 2 is a plan view illustrating an enlargement of the region R of FIG. 1;

FIG. 3 is a sectional view illustrating the cross-section taken along the line A-B of FIG. 2;

FIG. 4 is a sectional view illustrating that the coupling pad and the repair wiring line of FIG. 3 are coupled to each other;

FIG. 5 is a plan view illustrating an enlarged part of a touch screen panel according to a second embodiment of the present invention;

FIG. 6 is a sectional view illustrating the cross-section taken along the line C-D of FIG. 5;

FIG. 7 is a plan view illustrating a touch screen panel according to a third embodiment of the present invention;

FIG. 8 is a plan view illustrating an enlarged part of a touch screen panel according to a fourth embodiment of the present invention;

FIG. 9 is a sectional view illustrating the cross-section taken along the line E-F of FIG. 8;

FIG. 10 is a sectional view illustrating that the coupling pad and the repair wiring line of FIG. 9 are coupled to each other; and

FIG. 11 is a sectional view illustrating a part of a touch screen panel according to a fifth embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on another element or be indirectly on another element with one or more intervening elements interposed therebetween. Also, when an element is referred to as being “connected to” another element, it can be directly connected to another element or be indirectly connected to another element with one or more intervening elements interposed therebetween. Hereinafter, like reference numerals refer to like elements.

Detailed description of the exemplary embodiments are included in detailed description and drawings.

The aspects and characteristics of the present invention and a method of achieving the aspects and characteristics of the present invention now will be described more fully with reference to the accompanying drawings, in which exemplary embodiments of the invention are shown. This invention may, however, be embodied in many different forms and should not be construed as being limited to the embodiments set forth herein. In the drawings, when a part is coupled to another part, the part may be directly coupled to another part and the part may be electrically coupled to another part with another element interposed therebetween. In the drawings, some of the parts that are not related to the present invention may be omitted for clarity of description. The same reference numerals in different drawings represent the same element, and thus their description will be omitted.

Hereinafter, the present invention will be described with reference to the accompanying drawings.

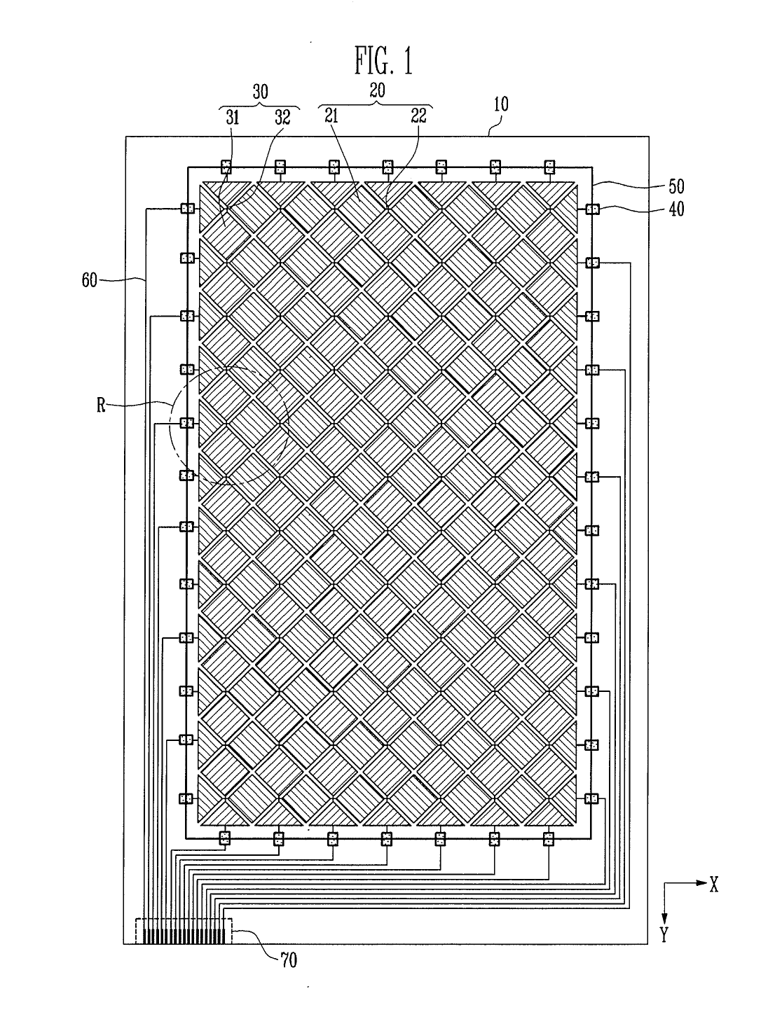

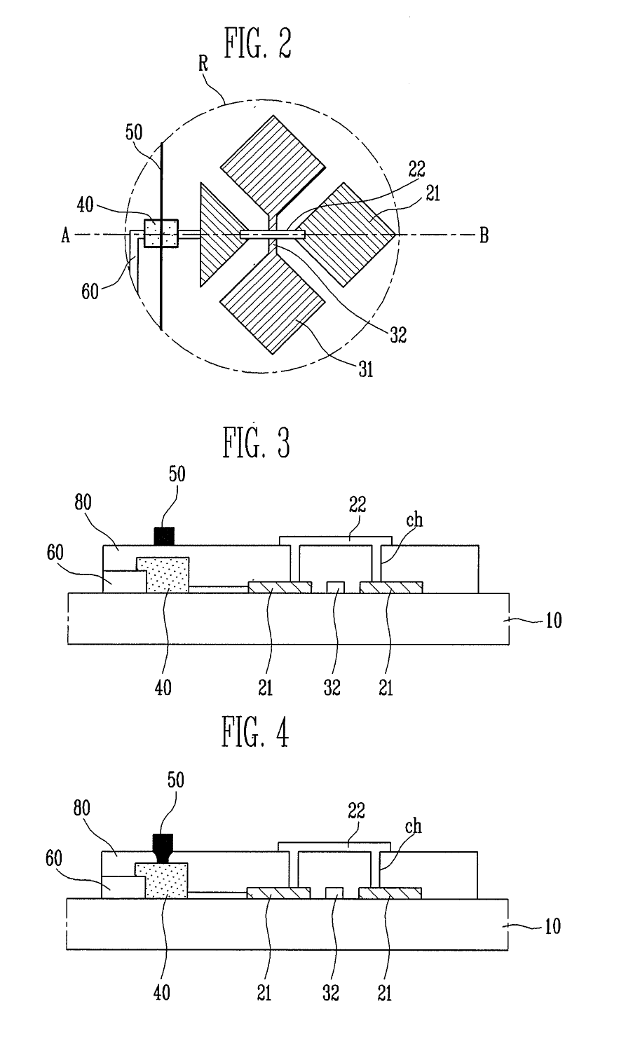

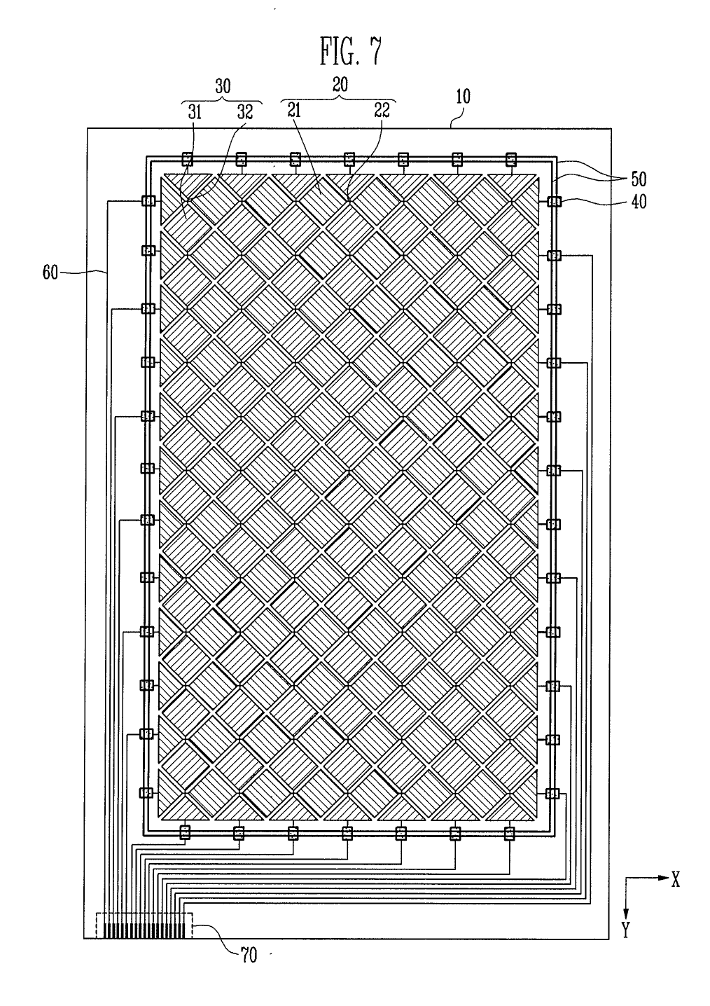

FIG. 1 is a plan view illustrating a touch screen panel according to a first embodiment of the present invention. FIG. 2 is a plan view illustrating an enlargement of the region R of FIG. 1. In particular, in FIGS. 1 and 2, a repair wiring line 50 is positioned above coupling pads 40. However, the case in which the repair wiring line 50 is positioned below the coupling pads 40 with reference to FIGS. 5 and 6 will be described below.

The touch screen panel according to an exemplary embodiment of the present invention includes first sensing electrodes 20, second sensing electrodes 30, the coupling pads 40, and the repair wiring line 50.

The first sensing electrodes 20 and the second sensing electrodes 30 are formed on the substrate 10 to cross each other. For example, the first sensing electrodes 20 and the second sensing electrodes 30 are formed on the substrate 10 to cross each other. For example, the plurality of first sensing electrodes 20 may be longitudinally connected to one another in a first direction (for example, an X axis direction) to form rows of the first sensing electrodes 20 to be arranged in a second direction (for example, a Y axis direction) that crosses the first direction, and the plurality of second sensing electrodes 30 may be vertically connected to one another in the second direction to form columns of the second sensing electrodes 30 to be arranged in the first direction.

In addition, the sensing electrodes 20 and 30 may be respectively formed of sensing cells 21 and 31 having a set or predetermined area and coupling patterns 22 and 32 for respectively coupling the sensing cells 21 and 31.

For example, the first sensing electrodes 20 include the plurality of first sensing cells 21 arranged in the first direction at set or predetermined intervals and the plurality of first coupling patterns 22 for electrically coupling the first sensing cells 21. The second sensing electrodes 30 may include the plurality of second sensing cells 31 arranged in the second direction at set or predetermined intervals and dispersed between the first sensing cells 21 not to overlap the first sensing cells 21, and the plurality of second coupling patterns 32 for electrically coupling the second sensing cells 31.

The first sensing cells 21 and the second sensing cells 31 may be formed of a transparent conductive material such as indium tin oxide (ITO), carbon nanotube (CNT), and graphene.

In addition, the first coupling patterns 22 and/or the second coupling patterns 32 may be formed of the above transparent conductive material or a metal material.

The coupling pads 40 are formed to be coupled to both ends of a row of the first sensing electrodes 20 and both ends of a column of the second sensing electrodes 30, and are coupled to the repair wiring line 50 when a defect is generated in the sensing electrodes 20 and 30 to recover from the defect.

The coupling pads 40 may be integrated with the sensing electrodes 20 and 30 in order to simplify manufacturing processes. Therefore, the coupling pads 40 may be formed of the same material as the sensing electrodes 20 and 30.

In addition, the coupling pads 40, which have to be electrically coupled to the sensing electrodes 20 and 30, may be positioned in an inactive region such as a peripheral region defining the outline of the active region in which the sensing electrodes 20 and 30 are positioned.

The coupling pads 40 may be positioned in different layers from the sensing electrodes 20 and 30 coupled thereto and may have the same material as the sensing electrodes 20 and 30. However, the coupling pads 40 may be formed of a metal material.

The repair wiring line 50 is coupled to the coupling pad 40 that is coupled to the corresponding sensing electrode when a defect is generated in a specific sensing electrode and may be positioned on a side of each of the coupling pads 40 with an insulating layer 80 (refer to FIG. 3) interposed between the coupling pads 40 and the repair wiring line 50.

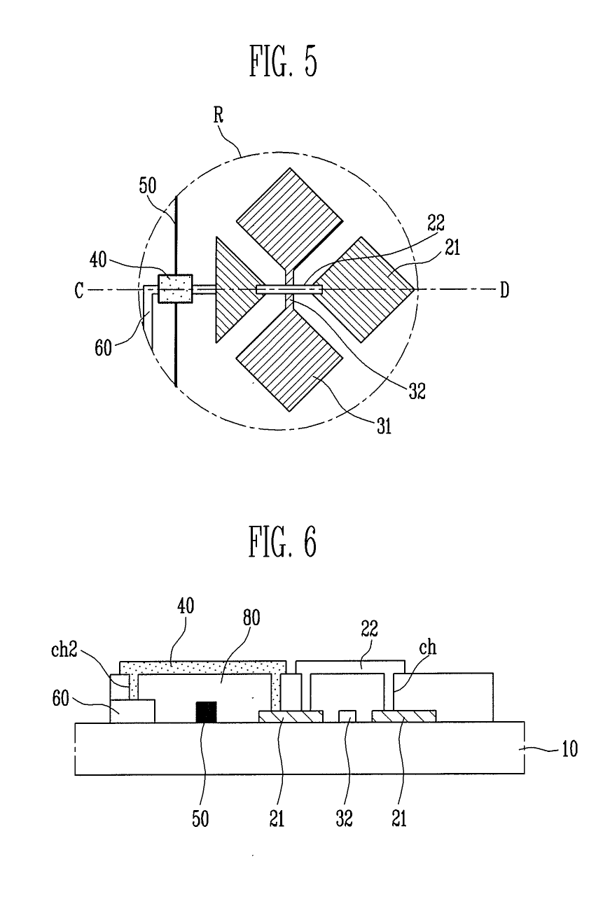

In FIGS. 3 and 4, an embodiment in which the repair wiring line 50 is formed above the coupling pads 40 with the insulating layer 80 interposed is illustrated. In FIGS. 5 and 6, an embodiment in which the repair wiring line 50 is formed below the coupling pad 40 with the insulating layer 80 interposed is illustrated.

Driving wiring lines 60 are coupled to the coupling pads 40 so that the sensing electrodes 20 and 30 may be coupled to an external touch driving circuit (not shown) through a pad unit 70 (shown in FIG. 7).

The driving wiring lines 60 may be positioned at the inactive region outside of the active region on which an image is displayed and may be coupled to one of the two coupling pads 40 formed at both ends of a row of the sensing electrodes 20 or at both ends of a column of the sensing electrodes 30 to be electrically coupled to the sensing electrodes 20 and 30.

In addition, the driving wiring lines 60 and the repair wiring line 50 may be formed of a low resistance material such as Mo, Ag, Ti, Cu, Al, and Mo/Al/Mo, other than the transparent conductive material used for forming the sensing electrodes 20 and 30.

The insulating layer 80 may be formed of silicon oxide SiOx or silicon nitride SiNx.

FIG. 3 is a sectional view illustrating the cross-section taken along the line A-B of FIG. 2. FIG. 4 is a sectional view illustrating that the coupling pad 40 and the repair wiring line 50 of FIG. 3 are coupled to each other.

Referring to FIGS. 2 and 3, the second sensing cells 31 are coupled by the second coupling patterns 32 positioned at the same layer, and the first sensing cells 21 are coupled by the first coupling patterns 22 positioned at different layers.

The first coupling patterns 22 couple the first sensing cells 21 that are separated from each other through contact holes ch formed in the insulating layer 80 with the insulating layer 80 interposed between the second coupling patterns 32 and first coupling patterns 22.

However, since the structures of the first sensing electrodes 20 and the second sensing electrodes 30 are not limited to the above, the first sensing cells 21 and the second sensing cells 31 may be positioned at different layers. Other suitable structures in which the plurality of first sensing cells 21 are coupled by the first coupling patterns 22 and the plurality of second sensing cells 31 are coupled by the second coupling patterns 32 may be used.

Therefore, in the accompanying drawings, the first sensing electrodes 20 and the second sensing electrodes 30 formed on the substrate 10 are illustrated as an exemplary embodiment. The first sensing electrodes 20 and the second sensing electrodes 30 may be positioned on different layers in other embodiments.

As an example, the present invention will be described in a case when one first coupling pattern 22 included in a first sensing electrode 20 is broken or damaged through scratching during manufacturing processes.

In this case, since a partial sensing cell included in the corresponding damaged sensing electrode is no longer electrically coupled to the driving wiring line due to the breaking of the first coupling pattern 22, a touch operation may not be successfully performed.

However, as illustrated in FIG. 4, when the two coupling pads 40 respectively formed at both ends of the corresponding row or column of the sensing electrodes are coupled to the repair wiring line 50 positioned above the coupling pads 40, since an additional electric path is formed, all of the sensing cells included in the corresponding row or column of the sensing electrodes are electrically coupled to the driving wiring lines so that the row or column of the sensing electrodes in which the defect is generated successfully operates again.

Coupling between the coupling pads 40 and the repair wiring line 50 positioned above the coupling pads 40 may be performed through laser welding.

In addition, in the case where a short is generated between coupling patterns, after cutting the shorted coupling pattern, the repair wiring line 50 is coupled to the coupling pads 40 like in the case when broken wire is generated so that the defect may be repaired.

Therefore, in the case when a defect is generated in a specific sensing electrode due to the breaking of wire or the forming of a short, since the defect may be repaired by the repair wiring line 50, manufacturing cost may be reduced.

FIG. 5 is a plan view illustrating an enlarged main part of a touch screen panel according to a second embodiment of the present invention. FIG. 6 is a sectional view illustrating the cross-section taken along the line C-D of FIG. 5. In particular, in FIGS. 5 and 6, an embodiment in which the repair wiring line 50 is formed below the coupling pads 40 is illustrated.

In the present embodiment, since the repair wiring line 50 is positioned at the same layer as the driving wiring line 60, the repair wiring line 50 and the driving wiring line 60 may be formed of the same material in the same process so that the number of process masks may be reduced.

In addition, since the Coupling pads 40 are positioned on the insulating layer 80, the coupling pads 40 may be electrically coupled to the driving wiring line 60 and the first sensing cell 21 through a contact hole ch2 formed in the insulating layer 80.

According to the present embodiment, like in the above-described first embodiment, the coupling pads 40 and the repair wiring line 50 may be coupled to each other by laser welding. Since the other structures are substantially the same, description of the same will be omitted.

FIG. 7 is a view illustrating a touch screen panel according to a third embodiment of the present invention.

In addition, at least one repair wiring line 50 may be formed in the touch screen panel according to the exemplary embodiment of the present invention. Only one repair wiring line 50 is illustrated in FIG. 1, and two repair wiring lines 5 are illustrated in FIG. 7. The number of repair wiring lines may vary according to the size and purpose of the panel.

Therefore, in some embodiments, a plurality of repair wiring lines 50 are formed so that the defects concurrently (e.g., simultaneously) generated by many sensing electrodes may be repaired.

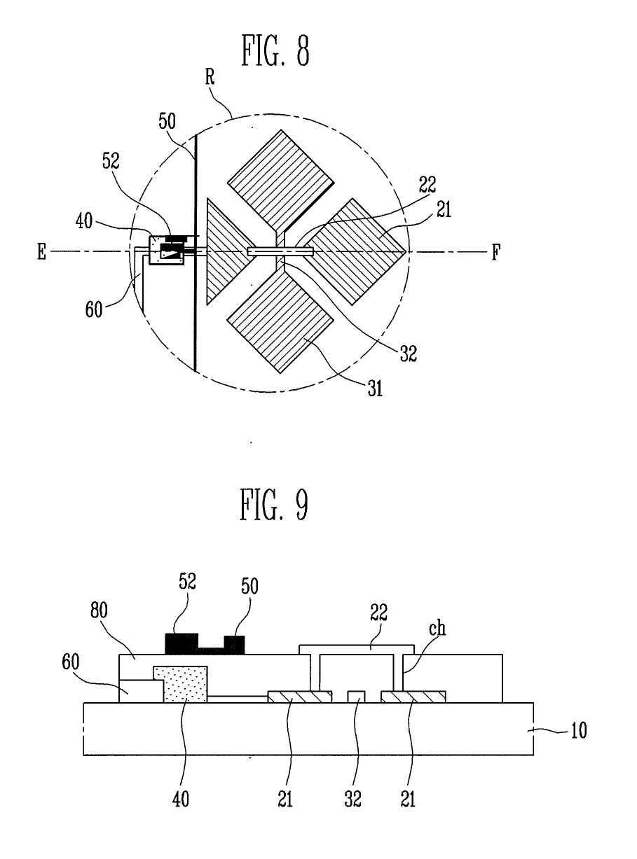

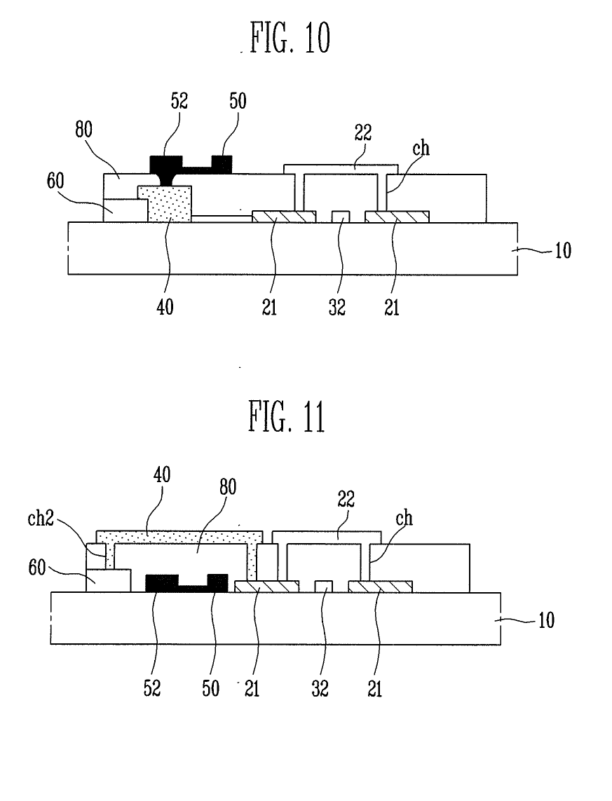

FIG. 8 is a plan view illustrating an enlarged part of a touch screen panel according to a fourth embodiment of the present invention. FIG. 9 is a sectional view illustrating the cross-section taken along the line E-F of FIG. 8. FIG. 10 is a sectional view illustrating that the coupling pad 40 and the repair wiring line 50 of FIG. 9 are coupled to each other. FIG. 11 is a sectional view illustrating a part of a touch screen panel according to a fifth embodiment of the present invention.

The repair wiring line in each of the touch screen panels according to the fourth embodiment and the fifth embodiment further includes a plurality of coupling units 52. The fourth embodiment is related to the above first embodiment and the fifth embodiment is related to the above second embodiment.

When the repair wiring line 50 is coupled to the coupling pad 40 like in the above first and second embodiments, a defect may be generated in the process of laser welding, and the coupling process is difficult.

Therefore, an additional coupling unit 52 coupled from the repair wiring line 50 to the coupling pad 40 may be formed.

Referring to FIGS. 8 and 9, in the repair wiring line 50, the coupling unit 52 protrudes to one side at the position corresponding to the coupling pad 40.

Therefore, when a defect is generated, without coupling the repair wiring line 50 to the coupling pad 40, as illustrated in FIG. 10, the coupling unit 52 that protrudes to one side may be coupled to the coupling pad 40 so that coupling may be conveniently and easily performed and that the generation of defect is reduced.

Referring to FIG. 11, when the repair wiring line 50 is formed below the coupling pad 40, the coupling unit 52 is formed in the repair wiring line 50 so that the above-described object and effect may be achieved.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A touch screen panel comprising:
a plurality of first and second sensing electrodes crossing each other;
a plurality of coupling pads, each of the coupling pads being coupled to a respective end of a corresponding one of the first sensing electrodes or the second sensing electrodes;
a repair wiring line; and
an insulating layer interposed between the coupling pads and the repair wiring line.

2. The touch screen panel as claimed in claim 1, wherein the coupling pads are positioned at a same layer as the first and second sensing electrodes.

3. The touch screen panel as claimed in claim 2, wherein the coupling pads comprise a same material as the first and second sensing electrodes.

4. The touch screen panel as claimed in claim 1, further comprising a plurality of driving wiring lines respectively coupled to the coupling pads.

5. The touch screen panel as claimed in claim 4, wherein each of the driving wiring lines is coupled to one of the two coupling pads coupled to both ends of a corresponding one of the first and second sensing electrodes.

6. The touch screen panel as claimed in claim 4, wherein the coupling pads respectively couple the driving wiring lines and the first and second sensing electrodes to each other through contact holes in the insulating layer.

7. The touch screen panel as claimed in claim 4, wherein the repair wiring lines are positioned at a same layer as the driving wiring lines.

8. The touch screen panel as claimed in claim 7, wherein the repair wiring lines comprise a same material as the driving wiring lines.

9. The touch screen panel as claimed in claim 1, wherein the repair wiring line comprises a plurality of repair wiring lines.

10. The touch screen panel as claimed in claim 1,
wherein the first sensing electrodes comprise a plurality of first sensing cells and a plurality of first coupling patterns for respectively coupling the plurality of first sensing cells to each other, and
wherein the second sensing electrodes comprise a plurality of second sensing cells and a plurality of second coupling patterns for respectively coupling the plurality of second sensing cells to each other.

11. The touch screen panel as claimed in claim 1, wherein the repair wiring line comprises a plurality of coupling units to be respectively coupled to the coupling pads.
